(19) United States
(12) Patent Application Publication
(10) Pub. No.: US 2013/0285856 A1
(43) Pub. Date: Oct. 31, 2013

(54) Position and Uncertainty Determination Using Staggered Reception of Position Reference Signals

(71) Applicant: QUALCOMM INCORPORATED, San Diego, CA (US)

(72) Inventors: Guttorm R. Opshaug, Santa Clara, CA (US); Jie Wu, San Diego, CA (US)

(73) Assignee: QUALCOMM INCORPORATED, San Diego, CA (US)

(21) Appl. No.: 13/674,765

(22) Filed: Nov. 12, 2012

Related U.S. Application Data
(60) Provisional application No. 61/640,506, filed on Apr. 30, 2012.

(51) Int. Cl. G01S 5/14

(52) U.S. Cl. CPC G01S 5/14
USPC 342/464

(57) ABSTRACT

Arrangements are detailed herein for determining a position and/or uncertainty of position of a mobile device. A plurality of positioning reference signals (PRSs) may be received by a mobile device. The plurality of PRSs may be transmitted at different times, separated by a predefined time interval, by multiple eNBs of a mobile network. Time of arrival values in relation to a received PRS that is used as a reference PRS may be determined. The time of arrival values for at least the subset of the received plurality of PRSs may be projected to the occasion of the reference PRS using the predefined time interval to create a set of projected time of arrival values.

### CROSS-REFERENCES TO RELATED APPLICATIONS

This application claims priority to co-pending provisional application No. 61/640,506, filed May 18, 2012, attorney docket number 121929P1, entitled “Position and Uncertainty Determination Using Staggered Reception of Position Reference Signals.” The provisional application is hereby incorporated by reference for all purposes.

### BACKGROUND

Determining a location of a mobile device, such as a cellular phone, may be accomplished in various ways. The Global Positioning System (GPS) is a space-based satellite navigation system that may be used to determine a position of a mobile device. In GPS, it may be necessary for the mobile device to receive timing signals from multiple (e.g., three or four) GPS satellites at substantially the same time (with slight timing differences at least being due to the speed of electromagnetic radiation propagating the different distances from the GPS satellites to the mobile device). Rather than using GPS, a mobile device may be able to use ground-based transmitters, such as cellular network base stations of a wireless communication network, in order to determine a location.

However, for eNBs (evolved node Bs), which are used in LTE (long term evolution) networks, in order to be able to accurately determine a location of a mobile device, position calculations may need to be handled differently due to the configuration of the mobile device and/or the eNBs.

### SUMMARY

Various arrangements are presented herein for determining a location of a mobile device and, possibly, an uncertainty of the position of the mobile device. In some embodiments, a method is presented. The method may include receiving, by a mobile device, a plurality of positioning reference signals (PRSs). The plurality of PRSs may be transmitted at a plurality of PRS occasions by a plurality of eNBs of a mobile network. A predefined time interval may separate consecutive PRS occasions. A received PRS of the plurality of PRSs may be used as a reference PRS occasion. The method may include determining, by the mobile device, time of arrival values in relation to the reference PRS occasion for at least a subset of the received plurality of PRSs. The method may include projecting, by the mobile device, the time of arrival values for at least the subset of the received plurality of PRSs to the reference PRS occasion using the predefined time interval to create a set of projected time of arrival values.

Embodiments of such a method may include one or more of the following: The method may include calculating, by the mobile device, a set of time difference of arrival values using the reference PRS occasion and the projected times of arrival values. The method may include transmitting, by the mobile device, the set of time difference of arrival values to the mobile network. The method may include calculating, by the mobile device, a position of the mobile device using the set of time difference of arrival values. A first PRS of the plurality of PRSs may be received at least the predefined time interval before a second PRS of the plurality of PRSs. A first PRS of the plurality of PRSs may be received during a same PRS occasion as a second PRS of the plurality of PRSs. Each of the plurality of PRSs may originate from a different eNB of the plurality of eNBs of the mobile network. The method may include calculating, by the mobile device, a plurality of uncertainty values using a clock period of a clock of the mobile device, and the predefined time interval for the time of arrival values in relation to the reference PRS occasion for at least the subset of the received plurality of PRSs. Each uncertainty value of the plurality of uncertainty values may correspond to a time of arrival value of the time of arrival values. The method may include calculating, by the mobile device, a time difference uncertainty value for a time difference of arrival value of the set of time difference of arrival values using: a reference occasion uncertainty value associated with the reference PRS occasion, and an uncertainty value of the plurality of uncertainty values. The method may include transmitting, by the mobile device, the time difference uncertainty value to the mobile network. The method may include calculating, by the mobile device, a position uncertainty of the mobile device using the time difference uncertainty value.

In some embodiments, a mobile device is presented. The mobile device may include a processor. The mobile device may include a memory communicatively coupled with and readable by the processor and having stored therein processor-readable instructions. When executed by the processor, the processor-readable instructions may cause the processor to receive a plurality of positioning reference signals (PRSs). The plurality of PRSs may be transmitted at a plurality of PRS occasions by a plurality of eNBs of a mobile network. A predefined time interval may separate consecutive PRS occasions. A received PRS of the plurality of PRSs may be used as a reference PRS occasion. When executed by the processor, the processor-readable instructions may cause the processor to determine time of arrival values in relation to the reference PRS occasion for at least a subset of the received plurality of PRSs. When executed by the processor, the processor-readable instructions may cause the processor to project the time of arrival values for at least the subset of the received plurality of PRSs to the reference PRS occasion using the predefined time interval to create a set of projected time of arrival values.

Embodiments of such a mobile device may include one or more of the following: The processor-readable instructions may further comprise processor-readable instructions which, when executed by the processor, cause the processor to calculate a set of time difference of arrival values using the reference PRS occasion and the projected times of arrival values. The processor-readable instructions may further comprise processor-readable instructions which, when executed by the processor, cause the processor to cause the set of time difference of arrival values to be transmitted the mobile network. The processor-readable instructions may further comprise processor-readable instructions which, when executed by the processor, cause the processor to calculate a position of the mobile device using the set of time difference of arrival values. A first PRS of the plurality of PRSs may be received at least the predefined time interval before a second PRS of the plurality of PRSs. A first PRS of the plurality of PRSs may be received by the mobile device during a same PRS occasion as a second PRS of the plurality of PRSs. Each of the plurality of PRSs may originate from a different eNB of the plurality of eNBs of the mobile network.

Embodiments of such a mobile device may additionally or alternatively include one or more of the following: The processor-readable instructions may further comprise processor-readable instructions which, when executed by the processor, cause the processor to calculate a plurality of uncertainty values using: a clock period of a clock of the mobile device, and the predefined time interval for the time of arrival values in relation to the reference PRS occasion for at least the subset of the received plurality of PRSs. Each uncertainty value of the plurality of uncertainty values may correspond to a time of arrival value of the time of arrival values. The processor-readable instructions may further comprise processor-readable instructions which, when executed by the processor, cause the processor to calculate a time difference uncertainty value for a time difference of arrival value of the set of time difference of arrival values using: a reference occasion uncertainty value associated with the reference PRS occasion, and an uncertainty value of the plurality of uncertainty values. The processor-readable instructions further comprise processor-readable instructions which, when executed by the processor, cause the processor to cause the time difference uncertainty value to be transmitted the mobile network. The processor-readable instructions may further comprise processor-readable instructions which, when executed by the processor, cause the processor to calculate a position uncertainty of the mobile device using the time difference uncertainty value.

In some embodiments, a computer program product is presented. A computer program product residing on a non-transitory computer-readable storage medium may be presented. The computer program product may comprise computer-readable instructions configured to cause a computer to receive a plurality of positioning reference signals (PRSs). The plurality of PRSs may be transmitted at a plurality of PRS occasions by a plurality of eNBs of a mobile network. A predefined time interval may separate consecutive PRS occasions. A received PRS of the plurality of PRSs may be used as a reference PRS occasion. The computer program product may comprise computer-readable instructions configured to cause the computer to determine time of arrival values in relation to the reference PRS occasion for at least a subset of the received plurality of PRSs. The computer program product may comprise computer-readable instructions configured to cause the computer to project the time of arrival values for at least the subset of the received plurality of PRSs to the reference PRS occasion using the predefined time interval to create a set of projected time of arrival values.

Embodiments of such a computer program product may include one or more of the following: The computer-readable instructions may further comprise computer-readable instructions which, when executed by the computer, cause the computer to calculate a set of time difference of arrival values using the reference PRS occasion and the projected times of arrival values. The computer-readable instructions may further comprise computer-readable instructions which, when executed by the computer, cause the computer to cause the set of time difference of arrival values to be transmitted the mobile network. The computer-readable instructions may further comprise computer-readable instructions which, when executed by the computer, cause the computer to calculate a position of a mobile device using the set of time difference of arrival values. A first PRS of the plurality of PRSs may be received at least the predefined time interval before a second PRS of the plurality of PRSs. A first PRS of the plurality of PRSs may be received by the computer during a same PRS occasion as a second PRS of the plurality of PRSs.

Each of the plurality of PRSs may originate from a different eNB of the plurality of eNBs of the mobile network. The computer-readable instructions may further comprise computer-readable instructions which, when executed by the computer, cause the computer to: calculate a plurality of uncertainty values using: a clock period of a clock of the computer, and the predefined time interval for the time of arrival values in relation to the reference PRS occasion for at least the subset of the received plurality of PRSs. Each uncertainty value of the plurality of uncertainty values may correspond to a time of arrival value of the time of arrival values.

Embodiments of such a computer program product may additionally or alternatively include one or more of the following: The computer-readable instructions may further comprise computer-readable instructions which, when executed by the computer, cause the computer to calculate a time difference uncertainty value for a time difference of arrival value of the set of time difference of arrival values using: a reference occasion uncertainty value associated with the reference PRS occasion, and an uncertainty value of the plurality of uncertainty values. The computer-readable instructions may further comprise computer-readable instructions which, when executed by the computer, cause the computer to cause the time difference uncertainty value to be transmitted the mobile network. The computer-readable instructions may further comprise computer-readable instructions which, when executed by the computer, cause the computer to calculate a position uncertainty of the computer using the time difference uncertainty value.

In some embodiments, an apparatus is presented. The apparatus may include means for receiving a plurality of positioning reference signals (PRSs). The plurality of PRSs may be transmitted at a plurality of PRS occasions by a plurality of eNBs of a mobile network. A predefined time interval may separate consecutive PRS occasions. A received PRS of the plurality of PRSs may be used as a reference PRS occasion. The apparatus may include means for determining time of arrival values in relation to the reference PRS occasion for at least a subset of the received plurality of PRSs. The apparatus may include means for projecting the time of arrival values for at least the subset of the received plurality of PRSs to the reference PRS occasion using the predefined time interval to create a set of projected time of arrival values.

Embodiments of such an apparatus may include one or more of the following: The apparatus may include means for calculating a set of time difference of arrival values using the reference PRS occasion and the projected times of arrival values. The apparatus may include means for transmitting the set of time difference of arrival values to the mobile network. The apparatus may include means for calculating a position of the apparatus using the set of time difference of arrival values. A first PRS of the plurality of PRSs may be received at least the predefined time interval before a second PRS of the plurality of PRSs. A first PRS of the plurality of PRSs may be received during a same PRS occasion as a second PRS of the plurality of PRSs. Each of the plurality of PRSs may originate from a different eNB of the plurality of eNBs of the mobile network. The apparatus may include means for calculating a plurality of uncertainty values using: a clock period of a clock of the apparatus, and the predefined time interval for the time of arrival values in relation to the reference PRS occasion for at least the subset of the received plurality of PRSs. Each uncertainty value of the plurality of uncertainty values may correspond to a time of arrival value of the time of arrival values. The apparatus may include means for calculating a time difference uncertainty value for a time difference of arrival value of the set of time difference of arrival values using: a reference occasion uncertainty value associated with the reference PRS occasion, and an uncertainty value of the plurality of uncertainty values. The apparatus may include means for transmitting the time difference uncertainty value to the mobile network. The apparatus may include means for calculating a position uncertainty of the apparatus using the time difference uncertainty value.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a wireless communication system.

FIG. 2 illustrates an embodiment of a diagram for determining time difference of arrival values using position reference signals and a single reference PRS occasion.

FIG. 3 illustrates an embodiment of a method for determining time difference of arrival (TDOA) values.

FIG. 4 illustrates an embodiment of a method for determining TDOA values and uncertainty values for the TDOA values.

FIG. 5 illustrates another embodiment of a method for determining TDOA values and uncertainty values for the TDOA values.

FIG. 6 illustrates an embodiment of a diagram for determining time difference of arrival values using position reference signal with multiple reference PRS occasions.

FIG. 7 illustrates an embodiment of a computer system.

### DETAILED DESCRIPTION OF THE INVENTION

In various types of wireless networks, such as LTE (long term evolution) and CDMA (code division multiplex access) networks, eNBs may periodically transmit reference signals that may be received by a mobile device; such reference signals may be used by a mobile device to determine location. The LTE standard (3GPP 36.211 v10.0.0.0 Chapter 6.10.4) defines such a reference signal, called the positioning reference signal (PRS). As an example, a base station of an LTE-based network, called an LTE evolved Node-B (eNB), may transmit a PRS once every 320 ms. In order for the 2D position of a mobile device to be determined, it is required for the mobile device to receive PRSs from at least three different eNBs. These received PRSs may be used to multilaterate the position of the mobile device. While the above description refers to PRSs as being specific to LTE, for embodiments detailed herein, it should be understood that PRSs may include other forms (e.g., according to other standards) of positioning signals which are received by a mobile device non-continuously.

In a conventional GPS-based position determining system, multiple signals from multiple GPS satellites used to determine position may be received substantially contemporaneously. In contrast, a mobile device operating on an LTE network may only be able to receive a PRS from a limited number of eNBs at a time, such as from a single eNB at a time. Therefore, in order to receive multiple PRSs from multiple eNBs, the mobile device may receive the PRSs in a series, separated by a period of time. For example, a first PRS may be received from a first eNB at time zero, followed by a second PRS being received from a second eNB approximately 320 ms later, and followed by a third PRS being received from a third eNB approximately an additional 320 ms later (thus, approximately 640 ms after the first PRS was received). The LPP (LTE Positioning Protocol) standard (3GPP 36.355 v 10.0.0.0 Chapter 6.5.1.2) defines an optional muting pattern for PRS transmission from an eNB, so a significantly longer period of time may elapse between when a PRS is received from a first eNB and additional PRSs are received from additional eNBs, which are necessary in order to determine the position of the mobile device.

Having such periods of time elapse between PRSs being received by the mobile device results in the position of the mobile device needing to be computed differently from a GPS-based position determining system. First, PRSs received at substantially different times, such as separated by hundreds of milliseconds (or, possibly, multiple seconds) may be used to determine a position of the mobile device, rather than the signal being received substantially at the same time as in GPS-based systems. Second, because the PRSs used to calculate the position of the mobile device may be separated by hundreds of milliseconds (or, possibly, multiple seconds), an amount of uncertainty of the location of the mobile device may exist. This uncertainty may be at least partially due to movement of the mobile device between when the PRSs were received. As a simple example of such uncertainty, if a mobile device is in a vehicle travelling at 60 miles per hour and 640 ms elapsed between when the first and last PRSs are received that are used for determining the position of the mobile device, the mobile device may have moved approximately 56 feet. Accordingly, the amount of uncertainty of a position of the mobile device may be desired to be calculated when PRSs are used for position calculations.

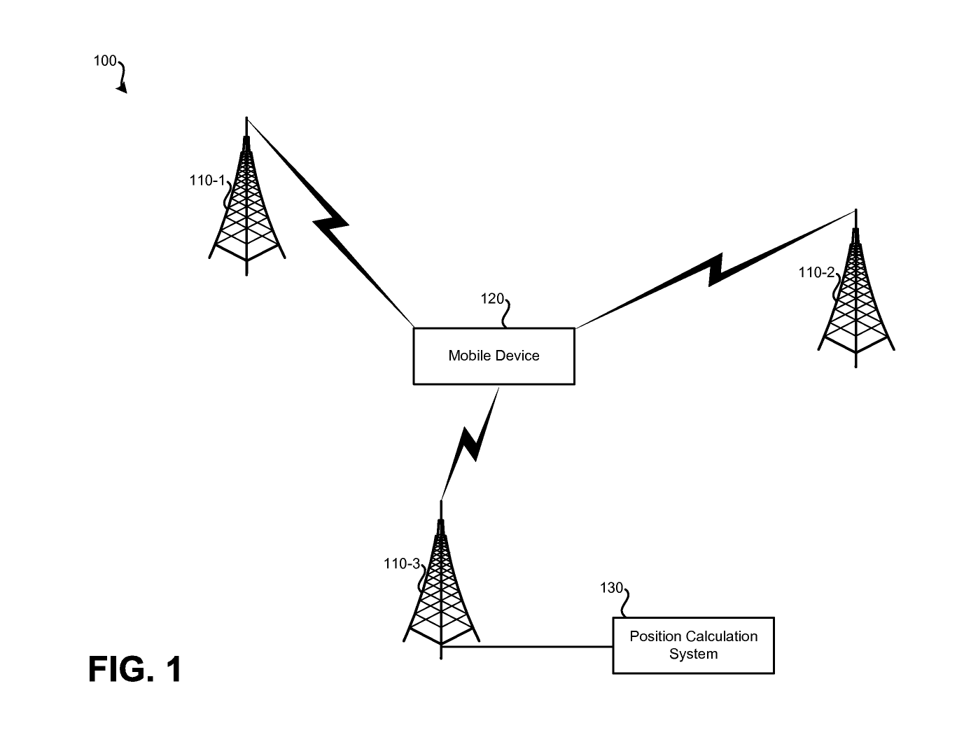

Systems and methods detailed herein may be used for determining the position of a mobile device using PRSs and for determining an amount of uncertainty associated with the determined position. FIG. 1 illustrates an embodiment of a wireless communication system 100. Wireless communication system 100 includes: eNBs 110, mobile device 120, and position calculation system 130. Mobile device 120 may be a device the position of which is to be determined. Mobile device 120 may be configured to communicate via a wireless communication network. For instance, mobile device 120 may be a cellular phone, vehicle subsystem (e.g., navigation system), or some other form of computerized device that can communicate with or receive signals from a wireless cellular network, such as a tablet computer, e-reader, or some other form of computerized device. More generally, a mobile device may be any device or system of which its position may be determined using a wireless communication network. While wireless communication system 100 illustrates a single mobile device, mobile device 120, it should be understood that many more mobile devices may be in communication with eNBs 110. Mobile device 120 may be configured to communicate via an LTE network and/or a CDMA network.

ENBs 110 may represent equipment that transmit and receive data with mobile device 120 (and, possibly, many additional mobile devices). ENBs 110 may be located at fixed positions. An eNB may contain one or more cells, where a cell may include an LTE transceiver with antennas that cover a sector (<0, 360 degrees of azimuth span around the eNB location). ENBs 110 may be configured to operate on a particular wireless communication network, such as an LTE or CDMA network and may be operated by a particular wireless service provider. ENBs 110 may be distributed over a geographical region. Mobile device 120 may be located sufficiently close to eNBs 110 to receive signals from multiple (e.g., three) eNBs. Based on the location of mobile device 120, which eNBs and the number of eNBs from which data, including PRSs, is received may vary. For example, it may be possible for mobile device 120 to receive data from ten eNBs. While three eNBs 110 are illustrated, eNBs 110 may include additional eNBs of the wireless communication network.

Each of eNBs 110 may periodically transmit a positioning reference signal (PRS), which may be received by the mobile device during a PRS occasion. The PRSs transmitted by eNBs may occur at the same time. For instance, a PRS transmitted by eNB 110-1 may happen at the same time as a PRS transmitted by eNB 110-3. In some embodiments, the PRSs transmitted by eNBs may not occur at the same time. However, knowledge of the absolute time or the time offset between the PRSs transmitted by eNBs may be required for proper mobile device position determination. As an example of this, two eNBs may transmit PRSs at different times, however it may be known that there is a fixed offset of 10 μs between when the two eNBs transmit each of their PRSs. Accordingly, a mobile device may be able to determine PRS occasions during which PRSs may be received from one or more eNBs. The fixed offset may be known based on a field (prsInfo) that specifies the PRS configuration of a neighboring cell.

The transmission of PRSs by a eNB may occur at fixed intervals. Such a fixed interval may be referred to as a PRS period. For instance, eNBs of wireless communication system 100 may each transmit a PRS every 160 ms. The PRS period may be selected by the operator of wireless communication system 100. For instance, PRS periods may be 160 ms, 320 ms, 640 ms, or 1280 ms in the LPP standard. It may be possible in some other protocol to use PRS periods of some other time. Each PRS may indicate an identifier of the eNB that transmitted the PRS.

A PRS occasion may occur once for each PRS period. A PRS occasion is a term for the section of an LTE transmission where the PRS is present. A PRS occasion may contain 1, 2, 4 or 6 repetitions of the PRS in consecutive subframes. The start of a PRS occasion may be referenced to a given slot inside a system frame number (SFN). The expected start location of a PRS occasion for a given cell is typically received by a mobile device via an LPP aiding message (OTDOA-ProvideAssistanceData). The receiver can use the aiding data and information about SFN and slot number in order to search for a PRS.

Mobile device 120 may be able to receive a limited number of PRSs at a time. For instance, mobile device 120 may only be able to receive a single PRS at a time (e.g., a single PRS during a single PRS occasion). As such, to receive multiple PRSs from multiple eNBs of eNBs 110, mobile device 120 may need to receive a PRS (such as from eNB 110-1), wait for a PRS period to elapse, receive a second PRS (such as from eNB 110-2), wait for another PRS period to elapse, and receive a third PRS (such as from eNB 110-3). As such, to receive three PRSs, at least two PRS periods may elapse between the first and third PRSs being received by mobile device 120. Said differently, multiple PRS occasions may need to be used for a mobile device to receive multiple PRSs.

Position calculation system 130 may be in communication with a specific eNB, such as eNB 110-3, or may be in communication with some or all of eNBs 110. If only in communication with a particular eNB of eNBs 110, each eNB of eNBs 110 may be in communication with a position calculation system 130. Position calculation system 130 may be configured to determine a position of mobile device 120 based on time of arrival (TOA) measurements conducted by mobile device 120 using the PRSs received from eNBs 110. As such, measurements conducted by mobile device 120 using the PRSs received from eNBs 110 may be transmitted to position calculation system 130 via at least one eNB of eNBs 110. While a single position calculation system 130 is present in the embodiment of wireless communication system 100, it should be understood that additional position calculation systems may be present. For example, a position calculation system may be present at multiple or all of eNBs 110. A position calculation system may be incorporated as part of mobile device 120. In such embodiments, mobile device 120 may use the TOA measurements to determine its own position.

Mobile device 120 or position calculation system 130 may be configured to calculate uncertainty estimates for the position of the mobile device 120. The uncertainty estimates may be based on the number of PRS periods that elapsed during collection of the PRSs and/or the clock period of a clock of the mobile device. Calculated uncertainty estimates (which may be referred to as OTDOA-MeasQuality of type rstd-Quality) may be transmitted via a eNB of eNBs 110 to position calculation system 130. In some embodiments, the uncertainty estimates may be calculated by position calculation system 130. Further, in some embodiments, position and/or uncertainty calculations may be calculated by the mobile device 120. In such embodiments, measurements related to PRSs made by the mobile device may not be transmitted to a eNB of eNBs 110. In such embodiments, the calculated position of the mobile device may not be known to components of the wireless network.

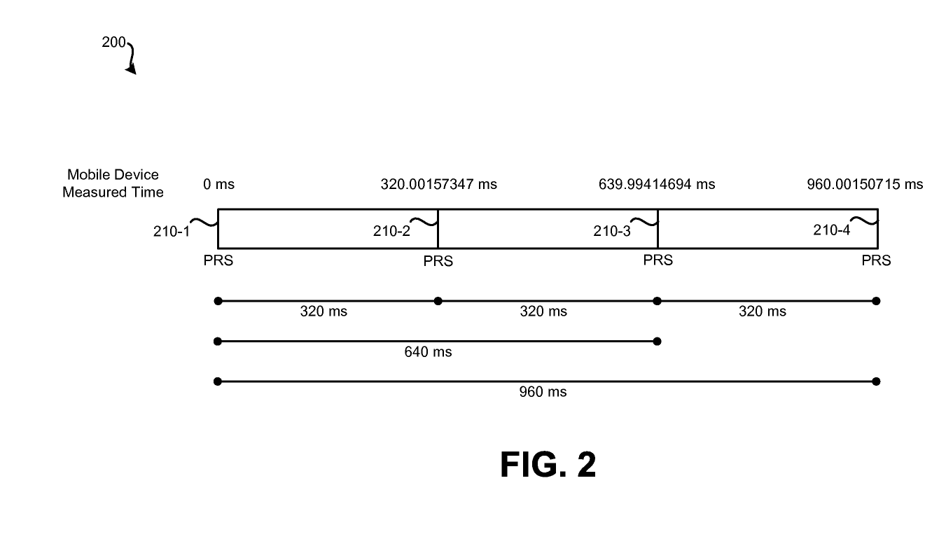

FIG. 2 illustrates an embodiment of a diagram 200 for determining time difference of arrival values of position reference signals (PRSs). In diagram 200, a mobile device receives multiple PRSs from multiple different eNBs. Referring to FIG. 1, mobile device 120 may receive PRS 210-1 at a first time (at a first PRS occasion) from eNB 110-1, approximately a PRS period later (at the second PRS occasion), PRS 210-2 may be received by mobile device 120 from eNB 110-2, approximately another PRS period later (at the third PRS occasion), PRS 210-3 may be received by mobile device 120 from eNB 110-3, and a third PRS period later, PRS 210-4 may be received by mobile device 120 (at the fourth PRS occasion) from a fourth eNB of eNBs 110 or a eNB of eNBs 110 that transmitted a PRS previously received by mobile device 120. While in this example a PRS was received at each PRS occasion, it should be understood that PRS occasions (and thus PRS periods) may pass without a PRS being received by the mobile device.

When a PRS is received by a mobile device, rather than an absolute time being measured, the time difference between when the PRS is received and another PRS being received is measured by the mobile device. As such, when multiple PRSs are received by a mobile device, one of the PRSs may be used as a reference PRS and a relative time measurement until (or since) a PRS received from another eNB may be measured. Accordingly, an absolute time measurement of when a PRS is received may not be measured, rather the time of a PRS being received in relation to another PRS may be measured.

In diagram 200, PRS 210-1 is used as the reference PRS by the receiving mobile device. In other embodiments, the first received PRS does not necessarily need to be the reference PRS, rather the last, second, third, or some other received PRS may be used as the reference PRS. The reference PRS, in this example PRS 210-1, may be treated as received at time zero.

The mobile device may not attempt to make another PRS measurement until approximately at the end of the next PRS period (that is, the next PRS occasion). For example, if a wireless network (and the mobile device) is configured for PRS periods of 320 ms (each PRS occasion is 320 ms apart), the mobile device may not attempt to receive a PRS until approximately 320 ms later (for example, the mobile device may attempt to receive the PRS between 319 and 321 ms later). The mobile device may listen for a PRS from another eNB for a period of time, such as 1 ms, 2 ms, 4 ms, or 6 ms, around 320 ms after PRS 210-1 was measured.

In the time period between PRS 210-1 and PRS 210-2, other data may be exchanged between the mobile device and an eNB (which may be the same or a different eNB from which PRS 210-1 was received). Such data may be related to voice communications or some other type of data transfer between the wireless network and the mobile device. Similar transfers of data may occur between each of the other PRSs 210. PRS 210-2 may have been transmitted from a different eNB than PRS 210-1. At 320.00157347 ms after PRS 210-1 was measured by the mobile device, PRS 210-2 may be received by the mobile device. PRS 210-2 may have been transmitted from a different eNB than PRS 210-1. The reception of PRS 210-1 is unlikely to occur exactly 320 ms after the measurement of PRS 210-1. One reason for this may be a difference in distance from the eNB transmitting PRS 210-2 compared with the eNB transmitting PRS 210-1 resulting in propagation delay and uncertainty in the measurements of PRS 210-2 caused by the period of the clock of the mobile device and/or movement of the mobile device. Another reason for the above effect may be due to errors in times of transmissions (TOT) of the signals from the eNB transmitting PRS 210-2 and the eNB transmitting PRS 210-1 compared to their ideal times of transmission.

At 639.99414694 ms after PRS 210-1 was measured by the mobile device, PRS 210-3 may be received by the mobile device. PRS 210-3 may have been transmitted from a different eNB than PRS 210-1 and PRS 210-2. Approximately 640 ms corresponds to a second PRS occasion wherein two PRS periods having elapsed since PRS 210-1 was measured. Again, the measurement of PRS 210-3 is unlikely to occur exactly 320 ms after the measurement of PRS 210-2 or exactly 640 ms after PRS 210-1 because of a difference in distance from the eNB transmitting PRS 210-3 compared with the eNBs transmitting PRS 210-1 and PRS 210-2 and uncertainty in the measurements of PRS 210-3 caused by the period of the clock of the mobile device, and/or movement of the mobile device, or by TOT errors of the eNBs.

At 960.00150715 ms after PRS 210-1 was measured by the mobile device, PRS 210-4 may be received by the mobile device. Around 960 ms, the mobile device may be listening for a PRS because it corresponds to a PRS occasion. PRS 210-4 may have been transmitted from a different eNB than PRSs 210-1 through 210-3. This corresponds to three PRS periods having elapsed since PRS 210-1 was measured. Again, the measurement of PRS 210-4 is unlikely to occur exactly 320 ms after the measurement of PRS 210-3, exactly 640 ms after PRS 210-2, or exactly 960 ms after the measurement of PRS 210-1 because of a difference in distance from the eNB transmitting PRS 210-4 compared with the eNBs transmitting PRSs 210-1 through PRS 210-3 and uncertainty in the measurements of PRS 210-4 caused by the period of the clock of the mobile device and/or movement of the mobile device or by TOT errors of the eNBs.

While FIG. 2 illustrates four PRSs being received by a mobile device, it should be understood that a greater number of PRSs may be received by the mobile device. Further, a different reference PRS may be used, a different PRS period may be used by the wireless network, etc. Moreover, in some embodiments, it may be possible to measure PRSs from multiple eNBs during the same PRS occasion. For example, rather than four PRSs being received, with each PRS being received a PRS period apart (e.g., at separate PRS occasions), two PRSs may be received at a first PRS occasion and two PRSs may be received at a second PRS occasion.

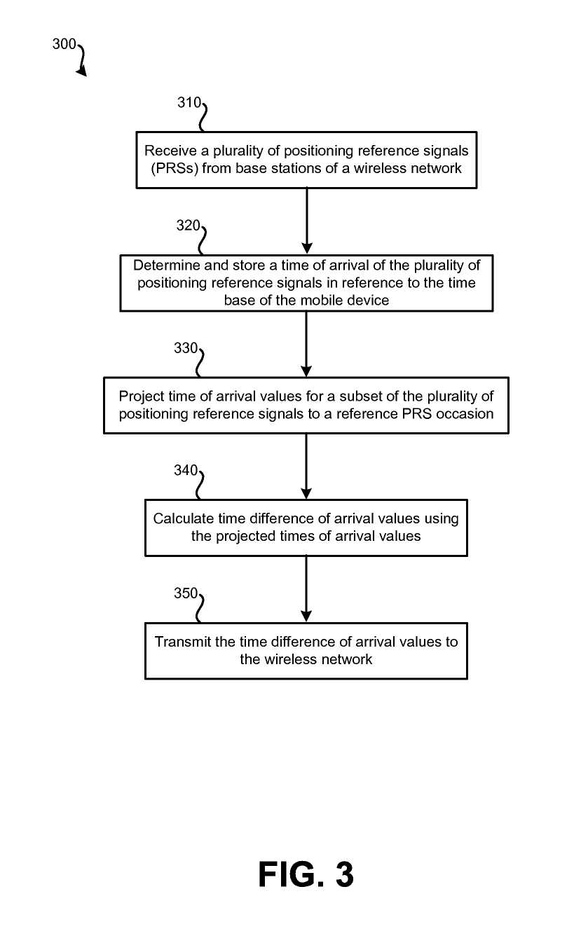

FIG. 3 illustrates an embodiment of a method 300 for determining time difference of arrival (TDOA) values. These TDOA values may be based on when PRSs are received by a mobile device. Such time difference of arrival values may be used for determining a location of the mobile device and/or an uncertainty of the mobile device's position. Each step of method 300 may be performed by a mobile device, such as mobile device 120 of FIG. 1. The mobile device may be in a region where in can receive PRSs from multiple eNBs, such as from eNBs 110 of FIG. 1. The mobile device performing the steps of method 300 may be a computerized device. As such, means for performing method 300 generally include computers and computerized devices, such as cellular phones, tablet computers, e-book readers, etc.

At step 310, a plurality of positioning reference signals (PRSs) may be received by the mobile device. Each of these PRSs may be received separately from each other and may be received from different eNBs of a wireless communication network, such as an LTE or CDMA network (or some other type of wireless communication network). Referring to FIG. 2, a first PRS may be received by the mobile device, then after a PRS period (that is, at the next PRS occasion), a second PRS may be received from another eNB. After additional PRS periods, additional PRSs may be received from other eNBs. It may be possible for one or more PRS periods to elapse without a PRS being received by the mobile device at a PRS occasion. For instance, a PRS may be received from an eNB, then the next PRS may be received from another eNB two PRS periods later. When a PRS is received by the mobile device, a corresponding indication of time may be stored by the mobile device. The time may be in clock tick units.

At step 320, a time of arrival of the plurality of PRSs may be determined in reference to the time base of the mobile device and stored. This may occur at the mobile device as each PRS is received. Accordingly, a time, which may be in clock ticks, of the arrival of each PRS may be stored, at least temporarily, by the mobile device. One of the received PRSs may be used as a reference PRS occasion. The reference PRS occasion may be a PRS occasion which other PRS occasions are projected to. To determine position using PRSs, the absolute TOA of the PRSs is not used, rather, the TOA as compared to other PRSs is used. A reference PRS occasion may be the first one (for simplicity, this measurement is indicated as taken at time zero in clock ticks), or it could be any other time at which the mobile device received a PRS from an aiding reference eNB or aiding neighbor eNB was transmitting a PRS. For instance, Table 1 lists four times of arrival (TOA) measurements of PRSs, with each measurement occurring in clock time ticks. In this example, the first PRS occasion is used as the reference PRS occasion, and is indicated as occurring at time zero.

TABLE 1

| PRS Measurement | TOA in Clock Ticks (in hexadecimal) |
|---|---|
| TOA(0) (Reference) | 0x0000000000000000 |
| TOA(1) | 0x0000000000963230 |
| TOA(2) | 0x00000000012C634C |
| TOA(3) | 0x0000000001C2962E |

In Table 1, TOA(1) of the second received PRS occurs 963230 (in hex) clock ticks after the TOA(0) of the first PRS (used as the reference PRS occasion). TOA(2) of the third received PRS occurs 12C634C (in hex) clock ticks after TOA(0) of the reference PRS occasion. TOA(3) of the fourth received PRS occurs 1C2962E (in hex) after TOA(0) of the reference PRS occasion.

At step 320, a TOA of each received PRSs in relation to the reference PRS occasion is calculated and stored. Since PRSs may only be received by the mobile device from a limited number of base stations at a time, PRSs that are used to determine the position of the mobile device may be received one or more PRS periods apart (at different PRS occasions). In order to use the TOA values of the PRSs to determine distance, the TOA values may need to be “projected” to a common time for use in computing distance. Each TOA of the PRSs may be projected to the reference PRS occasion at step 330. “Projecting” refers to modifying TOA values from different PRS occasions to create TOA values in a reference PRS occasion. These new TOA values in the reference PRS occasion are referred to as projected TOA values.

Since the length in time of the PRS period (such as 320 ms) is known by the mobile device, it can be calculated how many PRS periods have elapsed between the TOA of the reference PRS occasion and the PRS occasions of each other received PRS. Therefore, for example, referring to Table 1, TOA(1), TOA(2), and TOA(3) can be projected to the reference PRS occasion. Accordingly, a projected TOA measurement value for each of TOA values (1) through (3) is calculated that indicates what time the corresponding PRS would have been received if the corresponding PRS had been received during the reference PRS occasion (rather than during a separate PRS occasion). The projected TOA measurements may be treated as TOA values that would have been measured by the mobile device had the eNBs of the wireless network transmitted the PRSs during the reference PRS occasion and such PRSs had been received by the mobile device during the reference PRS occasion. As such, each TOA value is projected to a single PRS occasion (the reference PRS occasion).

As an example of this, referring to FIG. 2, the TOA value of PRS 210-2 was determined to be 320.00157347 ms after reference PRS 210-1 (which is at time zero, for simplicity) was received. Since PRS 210-1 and PRS 210-2 occur on consecutive PRS occasions, projecting the TOA of PRS 210-2 to the reference PRS occasion of PRS 210-1 would involve subtracting one PRS period from the TOA of PRS 210-2. Therefore, the projected TOA measurement value of PRS 210-2 would be 0.00157347 ms. While this example is performed in seconds, it may also be performed in time ticks of the clock of the mobile device. Equation 1 provides an example of how TOA measurement values may be projected to the reference time.

TOA_{PROJ}(i)=TOAᵢ−TOA_{REF}−T_{PERIOD}·N(i) Eq. 1

In equation 1, TOA_{PROJ}(i) refers to the projected TOA measurement value of a PRS when projected to the reference PRS occasion. T_{PERIOD} refers to the PRS period length, which may be known to the mobile device (or the position calculation system performing the calculations), such as 320 ms. N(i) refers to the number of PRS periods that have elapsed between the reference PRS occasion and the PRS occasion of the TOA value that is being projected to the reference PRS occasion. TOA_{REF} refers to the time of arrival measurement of the PRS used for the reference PRS occasion. For simplicity, in embodiments detailed herein, the reference PRS used for the reference PRS occasion is treated as received by the mobile device at time (or clock tick) zero, therefore, in such embodiments, TOA_{REF} is zero.

As presented, for example, in Table 1, the number of clock ticks (seconds, or other unit of measure) that have elapsed between the reference PRS at the reference PRS occasion and the TOA of each PRS (TOAᵢ) in clock ticks may be measured and stored. In equation 1, the time due to one or more PRS periods between the reference PRS occasion and a received PRS may be subtracted to project the TOA of the received PRS to the reference PRS occasion. As such, the PRS, which corresponds to a PRS occasion other than the reference PRS occasion, may be projected to the reference PRS occasion.

Since each PRS is received during a PRS occasion, it can be determined the number of PRS periods that have elapsed between the reference PRS occasion and the PRS occasion of the received PRS. For TOA(1) of Table 1, a single PRS period (in this example, 320 ms) has elapsed. Therefore, T_{PERIOD′}N(i) may be 0.320*1=.320, in seconds. If equation 1 is being evaluated in clock ticks, 0.320 seconds may be converted to clock ticks. Alternatively, all the calculations may be performed in either seconds, clock ticks, or some other unit. Table 2 lists the TOA values of PRSs of Table 1 wherein the TOA of each PRS is projected to the reference PRS occasion in clock ticks.

TABLE 2

| PRS Measurements projected to the | |
|---|---|
| TOA of the reference PRS | Time (clock ticks, in decimal) |
| TOA_{PROJ}(0) | 0 |
| TOA_{PROJ}(1) | 48 |
| TOA_{PROJ}(2) | −180 |
| TOA_{PROJ}(3) | 46 |

It may be possible to determine the number of PRS periods that have elapsed between the reference PRS occasion and another PRS occasion because a PRS may be expected to be received in close proximity to the calculated PRS occasion based on the PRS period. In Table 2, the time, in clock ticks, for each TOA of Table 1 as projected to the reference PRS occasion is presented.

At step 340, the projected TOA values calculated at step 330 may be used to calculate time difference of arrival (TDOA) values. A number, n, projected TOA values would produce a number, n−1, TDOA values by subtracting one of the projected TOA values (the reference PRS TOA value) from all the other projected TOA values. Since the projected TOA of reference PRS is at time zero, the TDOA values resemble the projected TOA measurement values because TOA_{PROJ}(i)−0=TOA_{PROJ}(i). Accordingly, the TOA_{PROJ} values may be used as TDOA values if the TOA of the reference PRS is at time zero. Otherwise, calculation of differences between the projected TOA of each PRS and the TOA of the reference PRS may be necessary.

At step 350, the one or more TDOA values may be transmitted to the wireless network. These TDOA values may be used to determine a position of the wireless device. In some embodiments, a position calculation system, such as position calculation system 130 of FIG. 1, may receive the TDOA values from mobile device 120 via a base station of the wireless network and may use the TDOA values to calculate the location of the mobile device. An indication of the location may be transmitted to the mobile device via a base station of the wireless network. Position calculation system 130 may have access to additional information, such as a location (e.g., latitude, longitude and altitude coordinates) of the base stations, and a transmission time offset from an absolute reference time, which may be used in conjunction with the TDOA values in determining the location of the mobile device. In some embodiments, rather than transmitting the TDOA measurements to a position calculation system, the position of the mobile device may be determined on board the mobile device using the TDOA measurements. As such, the TDOA measurements may not need to be transmitted from the mobile device.

Further, it should be understood that various steps of method 300 may be performed by a position calculation system separate from the mobile device, such as the position calculation system of FIG. 1. For instance, a mobile device may perform step 310 and transmit the timing of the PRSs to the position calculation system via a wireless network. The position calculation system may perform steps 320 through 340, and may then calculate a position of the mobile device using the timing measurements of the PRSs made by the mobile device.

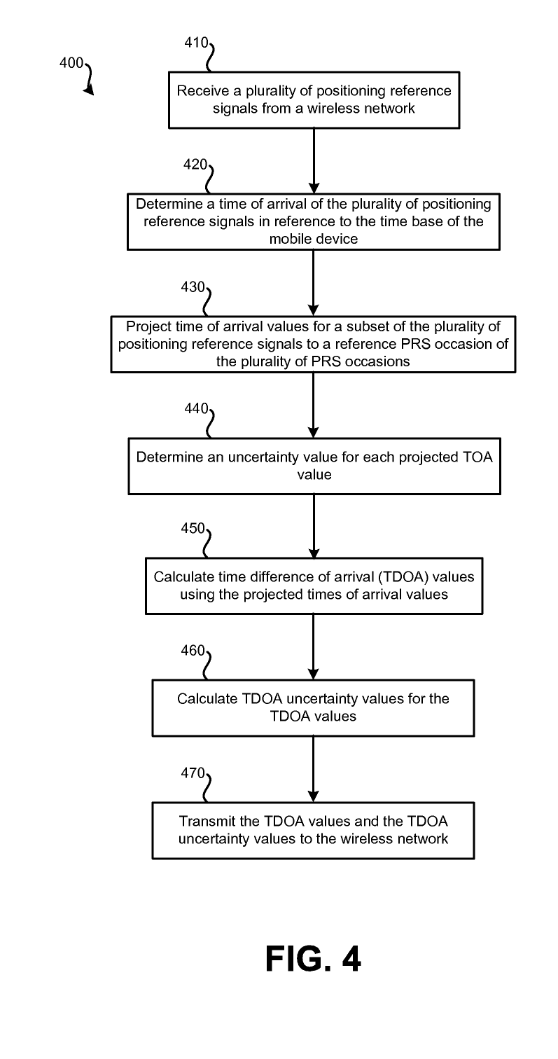

While method 300 is directed to determining only TDOA values, method 400 of FIG. 4 is directed to determining TDOA values and uncertainty values for the TDOA values. Since PRS periods elapse between the PRSs being received by the mobile device (rather than the measurements being made at the same time, such as in a typical GPS arrangement), the mobile device's position may change (e.g., a person walking with the mobile device, the mobile device being located in a moving vehicle, etc.). Depending on how fast the mobile device may move, the greater the amount of uncertainty in the position determined by the mobile device using the PRSs. Other factors may also affect the amount of uncertainty. For instance, the resolution of when the mobile device can determine arrival of a PRS may be limited by the clock period of a clock of the mobile device. As such, a minimum amount of uncertainty of a distance associated with a clock period (the distance electromagnetic radiation may propagate in a single clock period) may be present. Additionally, the frequency of the clock of the mobile device may experience an amount of drift, which affects uncertainty.

FIG. 4 illustrates an embodiment of a method 400 for determining time difference of arrival values and uncertainty values for the TDOA values. Each step of method 400 may be performed by a mobile device, such as mobile device 120 of FIG. 1. The mobile device may be in a region where it can receive PRSs from multiple eNBs, such as from eNBs 110 of FIG. 1. The mobile device performing the steps of method 400 may be a computerized device. As such, means for performing method 400 generally include computers and computerized devices, such as cellular phones, tablet computers, e-book readers, etc. The mobile device of method 400 may be stationary or in motion while method 400 is being performed; the mobile device may also be stationary for a portion of method 400 and in motion for a portion of method 400. In some embodiments, at least some steps of method 400 may be performed by a position calculating system located remote from the mobile device. For example, steps 420 through 460 may be performed by a position calculation system, such as position calculation system 130 of FIG. 1.

At step 410, a plurality of PRSs may be received by the mobile device. Each of these PRSs may be received at different times from each other (e.g., separated by one or more PRS periods, the length of each PRS period being standard for the wireless network) and may be received from different eNBs of the wireless network, such as an LTE network (or some other type of wireless network). Referring to FIG. 2, a first PRS may be received by the mobile device, then after one or more PRS periods, another PRS may be received from another eNB. After additional PRS periods, additional PRSs may be received from other eNBs. It may be possible for one or more PRS periods to elapse without a PRS being received by the mobile device at a PRS occasion. For instance, a PRS may be received from an eNB, then the next PRS may be received from another eNB two PRS periods later.

When a PRS is received by the mobile device, a corresponding indication of time, referred to as a time of arrival (TOA), may be stored by the mobile device. The time may be in clock tick units. At step 420, a time of arrival of the plurality of reference signals may be determined in reference to the time base of the mobile device. When a PRS is received by the mobile device, an indication of the time (such as in clock ticks or seconds) may be determined and stored by the mobile device. One of the PRS occasions may be used as a reference PRS occasion. Such a reference PRS occasion may be based on the first PRS received for the position/uncertainty calculation, or it could be some other PRS occasion in which an aiding reference cell or aiding eNB transmitted a PRS. As such, it may be possible for any received PRS to be used for the reference PRS occasion. Table 1, described in relation to method 300, lists four times of arrival (TOA) measurements of PRSs, with each measurement occurring in clock time ticks. The first PRS occasion may be used as the reference PRS occasion or some other PRS occasion may be used as the reference PRS occasion. The TOA of the first PRS is set at time zero for simplicity of the calculations, however it should be understood that the TOA of the first PRS may not be measured by the mobile device as at time zero.

At step 420, a TOA of each received PRS in relation to the reference PRS occasion is stored (either by the mobile device or the position calculating system). Since PRSs may only be received by the mobile device from a limited number of eNBs at a time, PRSs that are used to determine the position of the mobile device may be received one or more PRS periods apart (at different PRS occasions). In order to use the TOA measurement values of the PRSs to determine distance, the TOA values may be projected to the Reference PRS occasion. Each TOA of the PRSs may be projected to the reference PRS occasion at step 430. Since the PRS period (such as 320 ms) is known by the mobile device (and/or the position calculation system), and it can be determined how many PRS periods have elapsed between the TOA of the reference PRS at the reference PRS occasion and the TOA of each other PRS, each TOA (such as the TOA values of Table 1) can be projected to the reference PRS occasion. These projected TOA measurements may be treated as TOA values that would have been measured had the eNBs transmitted the PRSs during the reference PRS occasion and the mobile device having received the transmitted PRSs during the reference PRS occasion.

At step 440, an uncertainty value for each projected TOA value may be determined. The uncertainty value for each projected TOA value may take into account: 1) an inherent uncertainty caused by the resolution limit of the frequency of the clock of the mobile device; and/or 2) an amount of distance that the mobile device may have moved in the time between the TOA measurement of the reference PRS and the measurement of the TOA of the PRS used for the projected TOA value. For the second uncertainty value, a maximum possible distance that the mobile device may travel in an amount of time (e.g., a maximum possible speed) may be assumed. For instance, it may be assumed that the mobile device may travel no more than 70 mile per hour (e.g., it's assumed the fastest moving place the position of the mobile device may be determined is in a vehicle). Equation 2 illustrates a possible formula for computing the uncertainty of a projected TOA value.

TOA_{UNCERTAINTY}(i)=A(i)+T_{PERIOD}·N(i)·B(i) Eq. 2

In the above equation A(i) represents an a priori measurement uncertainty estimate that exists before projection. This a priori uncertainty measurement may be a function of signal-to-noise ratio (SNR) and PRS signal bandwidth. An uncertainty constant, B(i), which may be based on a maximum assumed speed estimate and/or a clock drift uncertainty estimate, may be multiplied by the amount of time between when the TOA of the reference PRS and the TOA of the PRS used to calculate the projected TOA to determine how far the mobile device may possibly have travelled in the time between the reception of the reference PRS and the PRS projected to the reference PRS occasion. T_{PERIOD} represents the length of the PRS period and N(i) is the number of the PRS periods that have elapsed between the reference PRS occasion and the initial PRS occasion associated with the projected TOA. Table 3 illustrates uncertainty values calculated for the projected TOA values of Table 2, assuming a PRS period of 320 ms, A(I) of 1, and a B(i) of 1.

TABLE 3

| PRS Measurements | |
|---|---|
| projected to the TOA of | Uncertainty in clock ticks |
| the reference PRS | (in decimal) |
| Projected | 1.0 |
| TOAUNCERTAINTY(0) | |
| Projected | 1.32 |
| TOAUNCERTAINTY(1) | |
| Projected | 1.64 |
| TOAUNCERTAINTY(2) | |
| Projected | 1.96 |
| TOAUNCERTAINTY(3) | |

As the amount of time (and, thus, the number of PRS periods) increases between the TOA of a PRS and the TOA of the reference PRS, the uncertainty due to possible movement of the mobile device may increase, assuming the mobile device is permitted to move. As such, since a greater number of PRS periods have elapsed between TOA(0) of the reference PRS and TOA(3) than between TOA(0) and TOA(1) or TOA(0) and TOA(2), the uncertainty of projected TOA(3) is greater than the uncertainty associated with TOA(1) or TOA(2).

In some embodiments, uncertainty calculations may take into account a fat path factor. A fat path may refer to multipath propagation of a PRS which is not resolvable. As such, a fat path may be caused by a non-line-of-sight reception of a PRS by the mobile device. A fat path may distort a correlation peak of a PRS received by the mobile device, thus negatively impacting a TOA measurement. Accordingly, a TOA of a PRS being received by the mobile device may cause the PRS to be recorded as received at an incorrect time due to the fat path. Equation 2B may be used to determine uncertainty of a time of arrival including uncertainty due to a fat path.

TOA_{UNCERTAINTY}(i)=A(i)+T_{PERIOD}·N(i)·B(i)+T_{FATPATH}(i) Eq. 2B

The magnitude of T_{FATPATH}(i) may be proportional to the correlation shape width of the PRS received by the mobile device or may be determined using a predefined look-up table. A PRS correlation shape may be compared to a predicted shape of a received PRS to determine whether a fat path peak is likely present. The fat path may result in a wider peak of a PRS being present than a non-fat path PRS. As such, the wider the peak of the PRS, the more uncertainty due to a fat path may be assumed. Depending on the phase relation of the individual multipath components that goes into generating a fat path, the resulting combination may appear more narrow than the nominal shape as well. As such, the more narrow the “fat path” compared to the nominal shape, the more the uncertainty can be assumed.

At step 450, the projected TOA values calculated at step 430 may be used to calculate time difference of arrival (TDOA) values. A number, n, projected TOA values (including the TOA value of the reference PRS occasion) would produce a number, n−1, TDOA values by subtracting the TOA value of the reference PRS occasion from each other projected TOA values.

At step 460, uncertainty for each TDOA value may be calculated. The uncertainty for each TDOA may be calculated according to equation 3. As such, the uncertainty for each projected TOA in conjunction with the uncertainty of the reference TOA may result in an increased uncertainty for TDOA values over projected TOA values.

$${TDOA}_{UNCERTAINTY} ( i ) = \sqrt{\begin{matrix}{( {TOA}_{UNCERTAINTY} ( ref ) )}^{2} + \\ {( {TOA}_{UNCERTAINTY} ( i ) )}^{2}\end{matrix}} \qquad Eq . 3$$

As such, the square of the uncertainty of a projected TOA value may be added with the square of the uncertainty of the reference TOA value of which, the squareroot may be calculated and may represent the uncertainty value for the TDOA value. Table 4 lists uncertainty values for TDOA values calculated based on the projected TOA values and the corresponding uncertainty values of the projected TOA values of Table 3. It should be understood, that the uncertainty of TDOA values may be calculated using other uncertainty equations, such as linearly combining the two uncertainties.

TABLE 4

| TDOA | TDOA Uncertainty Value in Tₛ (in decimal) |
|---|---|
| TDOA(1) | 1.6560 |
| TDOA(2) | 1.9208 |
| TDOA(3) | 2.2004 |

At step 470, the one or more TDOA values and/or the one or more TDOA uncertainty values may be transmitted to the wireless network. These TDOA values and the one or more TDOA uncertainty values may be used to determine a position of the wireless device with a certain amount of uncertainty. The TDOA uncertainties may be used to weight the corresponding TDOA values when calculating a position fix (e.g. through a weighted least squares solution) of the mobile device. In some embodiments, a position calculation system, such as position calculation system 130 of FIG. 1, may receive the TDOA values and/or the one or more TDOA uncertainty values from mobile device 120 via a eNB of the wireless network and may use the TDOA values and/or the one or more TDOA uncertainty values to calculate the location of the mobile device with an amount of uncertainty. An indication of the location and an indication of the amount of uncertainty may be transmitted to the mobile device via a eNB of the wireless network. Position calculation system 130 may have access to additional information, such as a location (e.g., latitude and longitude coordinates) of each eNB that transmitted a PRS used for the measurements. These locations of the eNBs may be used in conjunction with the TDOA values in determining the location of the mobile device. In some embodiments, rather than transmitting the TDOA measurements and/or the one or more TDOA uncertainty values to a position calculation system, the position of the mobile device with an amount of uncertainty may be determined on board the mobile device using the TDOA measurements and the one or more TDOA uncertainty values. As such, the TDOA measurements and/or the one or more TDOA uncertainty values may not need to be transmitted from the mobile device.

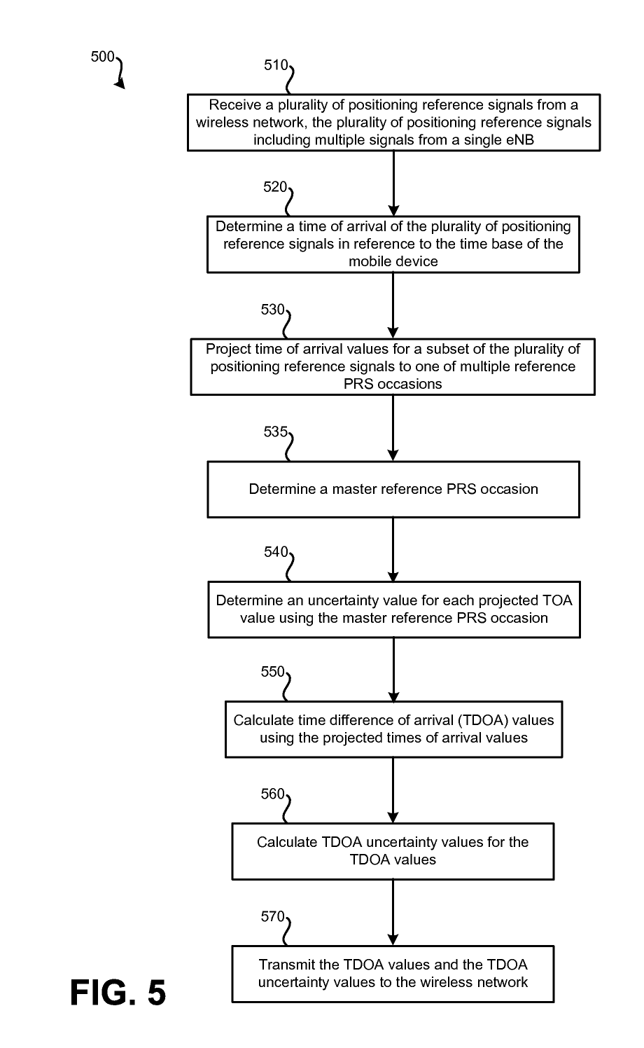

In method 500 of FIG. 5, rather than a single reference PRS occasion being used to calculate TDOA values, multiple reference occasions may be used. Multiple PRSs may be received by a mobile device from the same eNB during different PRS occasions with each of these PRSs being used as separate reference PRS occasions. Such an arrangement may decrease the amount of uncertainty, such as due to clock drift of the mobile device and the time difference between the reference PRS occasion and the received PRS being used to calculate a TDOA value. Each step of method 500 may be performed by a mobile device, such as mobile device 120 of FIG. 1. The mobile device may be in a region where it can receive PRSs from multiple eNBs, such as from eNBs 110 of FIG. 1. The mobile device may be configured to receive PRSs from multiple eNBs during the same PRS occasion. The mobile device performing the steps of method 500 may be a computerized device. As such, means for performing method 500 generally include computers and computerized devices, such as cellular phones, tablet computers, e-book readers, etc. The mobile device of method 500 may be stationary or in motion while method 500 is being performed; the mobile device may also be stationary for a portion of method 500 and in motion for a portion of method 500. Portions of method 500, such as steps 520 through 560, may be performed remote from the mobile device, such as by a position calculation system.

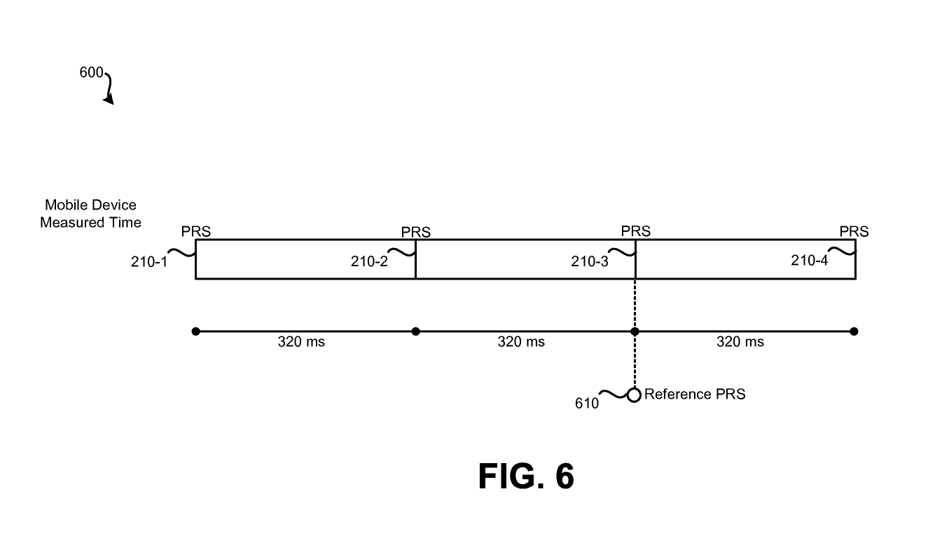

At step 510, a plurality of PRSs may be received by the mobile device. Each of these PRSs may be received at different times from each other (e.g., separated by one or more PRS periods, the length of each PRS period being standard for the wireless network) and may be received from different eNBs of the wireless network, such as an LTE network. Referring to FIG. 6, a first PRS 210-1 may be received by the mobile device, then after one or more PRS periods, another PRS may be received from another eNB. The PRS 210-1 may be used as a reference PRS occasion. After additional PRS periods, additional PRSs may be received from other eNBs: after one PRS period, PRS 210-2 is received, after a second PRS period, PRS 210-3 is received by the mobile device, and after a third PRS period, PRS 210-3 is received by the mobile device. During the third PRS occasion, an additional PRS is received: reference PRS 610 is received by the mobile device. Reference PRS 610 is received from the same eNB as PRS 210-1. Reference PRS 610 may be used as a second reference PRS occasion and PRS 210-1 may be used as a first reference PRS occasion.

When a PRS is received by the mobile device, a corresponding indication of time, referred to as a time of arrival (TOA), may be stored by the mobile device. The time may be in clock tick units. Over the course of multiple PRS periods, multiple PRSs may be received from a particular eNB. Some or all of these PRSs received from the particular eNB may be used to determine multiple reference PRS occasions. Referring to FIG. 6, reference PRS occasions exist for PRS 210-1 and Reference PRS 610. In the illustrated embodiment of FIG. 6, two reference PRS occasions exist, however it should be understood that in other embodiments greater numbers of reference PRS occasions may exist, such as at each PRS occasion.

Referring back to method 500 of FIG. 5, at step 520, a time of arrival of the plurality of reference signals may be determined in reference to the time base of the mobile device. Some or all of the PRS occasions associated with a particular eNB may be used as reference PRS occasions. Referring to FIG. 6, the reference PRS occasions are based on PRS 210-1 and reference PRS 610, both received from the same eNB. During the PRS occasion during which reference PRS 610 was received by the mobile device, a PRS 210-3 was also received by the mobile device from another eNB.

Following step 520, a TOA of each received PRS in relation to one of the reference PRS occasions may be stored. The TOA between a received PRS and one of the reference PRS occasions may be either forward or backward in time (that is, the reference PRS occasion may occur before or after the PRS was received). Since PRSs may only be received by the mobile device from a limited number of eNBs at a time, PRSs that are used to determine the position of the mobile device may be received one or more PRS periods apart. Therefore, the TOA value for one or more received PRSs may be determined using different reference PRS occasions than other PRSs. Each TOA of the received PRSs may be projected to a time of one of the reference PRS occasions at step 530. Since the PRS period (such as 320 ms) is known by the mobile device, and it can be calculated how many PRS periods have elapsed between the TOA of the reference PRS occasion being used and the TOA of the received PRS, each TOA can be projected to one of the reference PRS occasions. In some embodiments, one or more TOA values may be projected to a different reference PRS occasion than one or more other TOA values.

Referring to FIG. 6, PRS 210-1 may be projected either back to the reference PRS occasion of PRS 210-1 or forward to the reference PRS 610. PRS 210-3 may already exist at the reference PRS occasion of reference PRS 610. PRS 210-4 may be projected to the reference PRS occasion of reference PRS 610 because it is closer in time (thus reducing the amount of uncertainty). It should be noted, that although the reference PRS occasion of reference PRS 610 is closer in time to PRS 210-4, PRS 210-4 may also be projected to the reference PRS occasion of PRS 210-1. However, this may introduce a greater amount of uncertainty to the position determination through the uncertainty associated with clock drift.

Referring back to method 500 of FIG. 5, at step 530, since a reference PRS may be received during the same PRS occasion as another PRS, the PRS may not need to be projected to a reference PRS occasion because the PRS is already at the same occasion as a reference PRS. This can be seen in FIG. 6, where PRS 210-3 is at the same PRS occasion as reference PRS 610.

At step 535, a master reference PRS occasion may be determined The master reference PRS occasion may be selected from the multiple reference PRS occasions. Each of these uncertainty measurements may be projected to this master PRS occasion.

At step 540, an uncertainty value for each projected TOA value may be determined, such as in accordance with equation 2 or 2B using the master reference PRS occasion determined at step 535. The uncertainty value for each projected TOA value may take into account: 1) an inherent uncertainty caused by the resolution limit of the measurement based on the Gabor bandwidth and the signal-to-noise ratio of the signal (Cramer-Rao lower bound); and/or 2) an amount of distance that the mobile device may have moved in the time between the TOA measurement of the reference PRS occasion used for projection of the TOA measurement. For the second uncertainty value, a maximum possible distance that the mobile device may travel in an amount of time (e.g., a maximum possible speed) may be assumed. For instance, it may be assumed that the mobile device may travel no more than 70 mile per hour. Equation 2B illustrates a possible formula for computing the uncertainty of a projected TOA value. Since the reference PRS occasion for a particular projected TOA may have occurred during the same PRS occasion or closer in time than if a single reference PRS was used, the T_{PERIOD} N(i)·portion of the uncertainty equation may be reduced, thus decreasing the amount of uncertainty.

For example, referring to diagram 600 of FIG. 6, PRS 210-4 may be projected to the Reference PRS occasion associated with reference PRS 610 (instead of being projected to the Reference PRS occasion associated with PRS 210-1. When the TOA value of PRS 210-4 is projected to the Reference PRS occasion associated with reference PRS 610, the (T_{PERIOD}·N(i))·portion of the uncertainty equation (equation 2 or equation 2b) may be a third the magnitude than if the TOA value of PRS 210-3 was projected to the Reference PRS occasion associated with PRS 210-1. Thus, the amount of uncertainty associated with the projected TOA value for PRS 210-4 is decreased.

At step 550, the projected TOA values calculated at step 530 may be used to calculate time difference of arrival (TDOA) values. The TDOA values may be calculated in reference to different reference PRS occasions. Each TDOA value may be calculated in reference to the Reference PRS occasion that was used for projection at step 530. As such, the uncertainty of the TDOA values may rely on multiple reference PRS occasions. By using multiple reference PRS occasions, the amount of uncertainty associated with projected TOA values may be decreased, which in turn results in a lower amount of uncertainty being associated with TDOA values.

At step 560, uncertainty for each TDOA value may be calculated. The uncertainty for each TDOA may be calculated according to equation 3. The uncertainty for each projected TOA in conjunction with the uncertainty of the TOA associated with the reference PRS may result in an increased uncertainty for TDOA values over the uncertainty of the individual projected TOA values.

At step 570, the one or more TDOA values and the one or more TDOA uncertainty values may be transmitted to the wireless network. These TDOA values and the one or more TDOA uncertainty values may be used to determine a position of the wireless device with a certain amount of uncertainty. The TDOA uncertainty values may be used to weight the corresponding TDOA measurements when calculating a position fix (e.g. through a weighted least squares solution) of the mobile device in a similar manner to as detailed in reference to methods 300 and 400 of FIGS. 3 and 4, respectively. In some embodiments, rather than transmitting the TDOA values and the one or more TDOA uncertainty values to the wireless network, the mobile device may use the TDOA values and the one or more TDOA uncertainty values to calculate a position or area where the mobile device is located. In some embodiments, both transmission and calculation occur.

A hybrid positioning arrangement is also possible. In a hybrid arrangement, both a global navigation satellite system (GNSS), such as GPS, may be used in conjunction with PRS measurements. Such an arrangement may be useful if an insufficient number of GNSS satellites is received (such as one or two) to generate a position fix solely using the GNSS, but PRSs may additionally be received from multiple eNBs. If both PRS and GNSS signals are made with respect to the same user time scale, the measurements can be used interchangeably when generating a position fix. That is, a 2D fix could be generated with as few as 1 PRS measurement and 2 GNSS space vehicle (SV) measurements, or with 2 PRS measurement from different cells and 1 GNSS SV measurement. A master reference occasion may be aligned with the GNSS measurements.

Further, since in at least some GNSSs, such as GPS, positioning signals are continuously transmitted, the timing of when the GNSS positioning signals are measured may be scheduled to align with the reference PRS occasion. Conversely, the reference PRS occasion can be chosen to align as close in time as possible with a GNSS fix time.

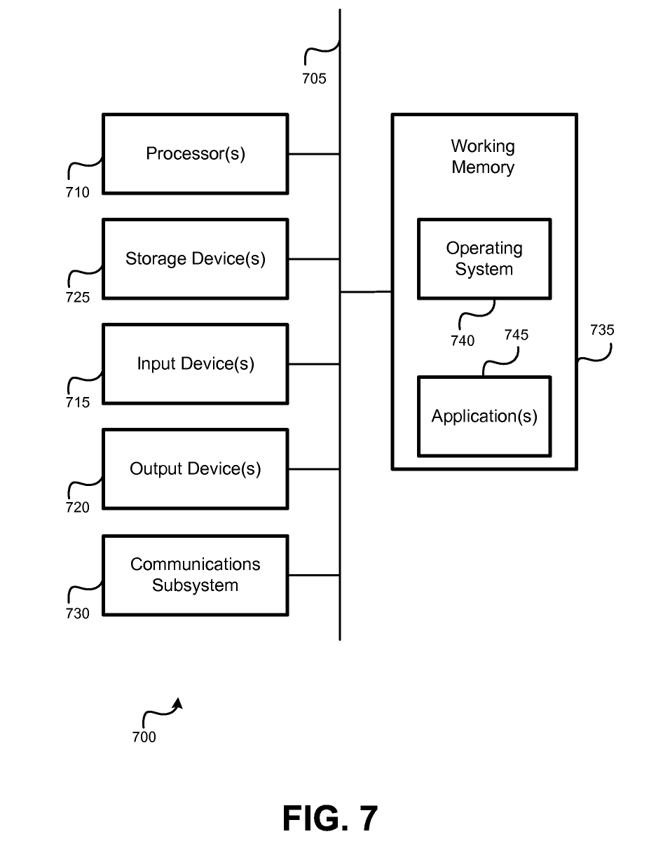

A computer system as illustrated in FIG. 7 may be incorporated as part of the previously described computerized devices. For example, computer system 700 can represent some of the components of the mobile devices, eNBs, and position calculation system. FIG. 7 provides a schematic illustration of one embodiment of a computer system 700 that can perform the methods provided by various embodiments, as described herein. It should be noted that FIG. 7 is meant only to provide a generalized illustration of various components, any or all of which may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include without limitation a mouse, a keyboard, and/or the like; and one or more output devices 720, which can include without limitation a display device, a printer, and/or the like.

The computer system 700 may further include (and/or be in communication with) one or more non-transitory storage devices 725, which can comprise, without limitation, local and/or network accessible storage, and/or can include, without limitation, a disk drive, a drive array, an optical storage device, a solid-state storage device, such as a random access memory (“RAM”) and/or a read-only memory (“ROM”), which can be programmable, flash-updateable, and/or the like. Such storage devices may be configured to implement any appropriate data stores, including without limitation, various file systems, database structures, and/or the like.

The computer system 700 might also include a communications subsystem 730, which can include without limitation a modem, a network card (wireless or wired), an infrared communication device, a wireless communication device, and/or a chipset (such as a Bluetooth device, an 802.11 device, a WiFi device, a WiMax device, cellular communication facilities, etc.), and/or the like. The communications subsystem 730 may permit data to be exchanged with a network (such as the network described below, to name one example), other computer systems, and/or any other devices described herein. In many embodiments, the computer system 700 will further comprise a working memory 735, which can include a RAM or ROM device, as described above.

The computer system 700 also can comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 725 described above. In some cases, the storage medium might be incorporated within a computer system, such as computer system 700. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 700, and/or might take the form of source and/or installable code, which, upon compilation and/or installation on the computer system 700 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 700) to perform methods in accordance with various embodiments of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer-readable medium, such as one or more of the non-transitory storage device(s) 725. Merely by way of example, execution of the sequences of instructions contained in the working memory 735 might cause the processor(s) 710 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 700, various computer-readable media might be involved in providing instructions/code to processor(s) 710 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 725. Volatile media include, without limitation, dynamic memory, such as the working memory 735.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700.

The communications subsystem 730 (and/or components thereof) generally will receive signals, and the bus 705 then might carry the signals (and/or the data, instructions, etc. carried by the signals) to the working memory 735, from which the processor(s) 710 retrieves and executes the instructions. The instructions received by the working memory 735 may optionally be stored on a non-transitory storage device 725 either before or after execution by the processor(s) 710.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bound the scope of the claims.

What is claimed is:

1. A method, comprising:
receiving, by a mobile device, a plurality of positioning reference signals (PRSs), wherein:
the plurality of PRSs are transmitted at a plurality of PRS occasions by a plurality of eNBs of a mobile network,
a predefined time interval separates consecutive PRS occasions; and
a received PRS of the plurality of PRSs is used as a reference PRS occasion;
determining, by the mobile device, time of arrival values in relation to the reference PRS occasion for at least a subset of the received plurality of PRSs; and
projecting, by the mobile device, the time of arrival values for at least the subset of the received plurality of PRSs to the reference PRS occasion using the predefined time interval to create a set of projected time of arrival values.

2. The method of claim 1, further comprising:
calculating, by the mobile device, a set of time difference of arrival values using the reference PRS occasion and the projected times of arrival values.

3. The method of claim 2, further comprising:
transmitting, by the mobile device, the set of time difference of arrival values to the mobile network.

4. The method of claim 2, further comprising:
calculating, by the mobile device, a position of the mobile device using the set of time difference of arrival values.

5. The method of claim 1, wherein a first PRS of the plurality of PRSs is received at least the predefined time interval before a second PRS of the plurality of PRSs.

6. The method of claim 1, wherein a first PRS of the plurality of PRSs is received during a same PRS occasion as a second PRS of the plurality of PRSs.

7. The method of claim 1, wherein:
each of the plurality of PRSs originates from a different eNB of the plurality of eNBs of the mobile network.

8. The method of claim 2, further comprising:
calculating, by the mobile device, a plurality of uncertainty values using:
a clock period of a clock of the mobile device, and
the predefined time interval for the time of arrival values in relation to the reference PRS occasion for at least the subset of the received plurality of PRSs, wherein
each uncertainty value of the plurality of uncertainty values corresponds to a time of arrival value of the time of arrival values.

9. The method of claim 8, further comprising:
calculating, by the mobile device, a time difference uncertainty value for a time difference of arrival value of the set of time difference of arrival values using:
a reference occasion uncertainty value associated with the reference PRS occasion, and
an uncertainty value of the plurality of uncertainty values.

10. The method of claim 9, further comprising:
transmitting, by the mobile device, the time difference uncertainty value to the mobile network.

11. The method of claim 9, further comprising:
calculating, by the mobile device, a position uncertainty of the mobile device using the time difference uncertainty value.

12. A mobile device, comprising:
a processor; and
a memory communicatively coupled with and readable by the processor and having stored therein processor-readable instructions which, when executed by the processor, cause the processor to:
receive a plurality of positioning reference signals (PRSs), wherein:
the plurality of PRSs are transmitted at a plurality of PRS occasions by a plurality of eNBs of a mobile network,
a predefined time interval separates consecutive PRS occasions; and
a received PRS of the plurality of PRSs is used as a reference PRS occasion;
determine time of arrival values in relation to the reference PRS occasion for at least a subset of the received plurality of PRSs; and
project the time of arrival values for at least the subset of the received plurality of PRSs to the reference PRS occasion using the predefined time interval to create a set of projected time of arrival values.

13. The mobile device of claim 12, wherein the processor-readable instructions further comprise processor-readable instructions which, when executed by the processor, cause the processor to:
calculate a set of time difference of arrival values using the reference PRS occasion and the projected times of arrival values.

14. The mobile device of claim 13, wherein the processor-readable instructions further comprise processor-readable instructions which, when executed by the processor, cause the processor to:
cause the set of time difference of arrival values to be transmitted the mobile network.

15. The mobile device of claim 13, wherein the processor-readable instructions further comprise processor-readable instructions which, when executed by the processor, cause the processor to:
calculate a position of the mobile device using the set of time difference of arrival values.

16. The mobile device of claim 12, wherein a first PRS of the plurality of PRSs is received at least the predefined time interval before a second PRS of the plurality of PRSs.

17. The mobile device of claim 12, wherein a first PRS of the plurality of PRSs is received by the mobile device during a same PRS occasion as a second PRS of the plurality of PRSs.

18. The mobile device of claim 12, wherein each of the plurality of PRSs originates from a different eNB of the plurality of eNBs of the mobile network.

19. The mobile device of claim 13, wherein the processor-readable instructions further comprise processor-readable instructions which, when executed by the processor, cause the processor to:
calculate a plurality of uncertainty values using:
a clock period of a clock of the mobile device, and
the predefined time interval for the time of arrival values in relation to the reference PRS occasion for at least the subset of the received plurality of PRSs, wherein
each uncertainty value of the plurality of uncertainty values corresponds to a time of arrival value of the time of arrival values.

20. The mobile device of claim 19, wherein the processor-readable instructions further comprise processor-readable instructions which, when executed by the processor, cause the processor to:
calculate a time difference uncertainty value for a time difference of arrival value of the set of time difference of arrival values using:
a reference occasion uncertainty value associated with the reference PRS occasion, and
an uncertainty value of the plurality of uncertainty values.

21. The mobile device of claim 20, wherein the processor-readable instructions further comprise processor-readable instructions which, when executed by the processor, cause the processor to:
cause the time difference uncertainty value to be transmitted the mobile network.

22. The mobile device of claim 20, wherein the processor-readable instructions further comprise processor-readable instructions which, when executed by the processor, cause the processor to:
calculate a position uncertainty of the mobile device using the time difference uncertainty value.

23. A computer program product residing on a non-transitory computer-readable storage medium, the computer program product comprising computer-readable instructions configured to cause a computer to:
receive a plurality of positioning reference signals (PRSs), wherein:
the plurality of PRSs are transmitted at a plurality of PRS occasions by a plurality of eNBs of a mobile network,
a predefined time interval separates consecutive PRS occasions; and
a received PRS of the plurality of PRSs is used as a reference PRS occasion;
determine time of arrival values in relation to the reference PRS occasion for at least a subset of the received plurality of PRSs; and
project the time of arrival values for at least the subset of the received plurality of PRSs to the reference PRS occasion using the predefined time interval to create a set of projected time of arrival values.

24. The computer program product of claim 23, wherein the computer-readable instructions further comprise computer-readable instructions which, when executed by the computer, cause the computer to:
calculate a set of time difference of arrival values using the reference PRS occasion and the projected times of arrival values.

25. The computer program product of claim 24, wherein the computer-readable instructions further comprise computer-readable instructions which, when executed by the computer, cause the computer to:
cause the set of time difference of arrival values to be transmitted the mobile network.

26. The computer program product of claim 24, wherein the computer-readable instructions further comprise computer-readable instructions which, when executed by the computer, cause the computer to:
calculate a position of a mobile device using the set of time difference of arrival values.

27. The computer program product of claim 23, wherein a first PRS of the plurality of PRSs is received at least the predefined time interval before a second PRS of the plurality of PRSs.

28. The computer program product of claim 23, wherein a first PRS of the plurality of PRSs is received by the computer during a same PRS occasion as a second PRS of the plurality of PRSs.

29. The computer program product of claim 23, wherein each of the plurality of PRSs originates from a different eNB of the plurality of eNBs of the mobile network.

30. The computer program product of claim 24, wherein the computer-readable instructions further comprise computer-readable instructions which, when executed by the computer, cause the computer to:
calculate a plurality of uncertainty values using:
a clock period of a clock of the computer, and
the predefined time interval for the time of arrival values in relation to the reference PRS occasion for at least the subset of the received plurality of PRSs, wherein
each uncertainty value of the plurality of uncertainty values corresponds to a time of arrival value of the time of arrival values.

31. The computer program product of claim 30, wherein the computer-readable instructions further comprise computer-readable instructions which, when executed by the computer, cause the computer to:
calculate a time difference uncertainty value for a time difference of arrival value of the set of time difference of arrival values using:
a reference occasion uncertainty value associated with the reference PRS occasion, and
an uncertainty value of the plurality of uncertainty values.

32. The computer program product of claim 31, wherein the computer-readable instructions further comprise computer-readable instructions which, when executed by the computer, cause the computer to:
cause the time difference uncertainty value to be transmitted the mobile network.

33. The computer program product of claim 31, wherein the computer-readable instructions further comprise computer-readable instructions which, when executed by the computer, cause the computer to:
calculate a position uncertainty of the computer using the time difference uncertainty value.

34. An apparatus, comprising:
means for receiving a plurality of positioning reference signals (PRSs), wherein:
the plurality of PRSs are transmitted at a plurality of PRS occasions by a plurality of eNBs of a mobile network,
a predefined time interval separates consecutive PRS occasions; and
a received PRS of the plurality of PRSs is used as a reference PRS occasion;
means for determining time of arrival values in relation to the reference PRS occasion for at least a subset of the received plurality of PRSs; and
means for projecting the time of arrival values for at least the subset of the received plurality of PRSs to the reference PRS occasion using the predefined time interval to create a set of projected time of arrival values.

35. The apparatus of claim 34, further comprising:
means for calculating a set of time difference of arrival values using the reference PRS occasion and the projected times of arrival values.

36. The apparatus of claim 35, further comprising:
means for transmitting the set of time difference of arrival values to the mobile network.

37. The apparatus of claim 35, further comprising:
means for calculating a position of the apparatus using the set of time difference of arrival values.

38. The apparatus of claim 34, wherein a first PRS of the plurality of PRSs is received at least the predefined time interval before a second PRS of the plurality of PRSs.

39. The apparatus of claim 34, wherein a first PRS of the plurality of PRSs is received during a same PRS occasion as a second PRS of the plurality of PRSs.

40. The apparatus of claim 34, wherein:
each of the plurality of PRSs originates from a different eNB of the plurality of eNBs of the mobile network.

41. The apparatus of claim 35, further comprising:
means for calculating a plurality of uncertainty values using:
a clock period of a clock of the apparatus, and
the predefined time interval for the time of arrival values in relation to the reference PRS occasion for at least the subset of the received plurality of PRSs, wherein
each uncertainty value of the plurality of uncertainty values corresponds to a time of arrival value of the time of arrival values.

42. The apparatus of claim 41, further comprising:
means for calculating a time difference uncertainty value for a time difference of arrival value of the set of time difference of arrival values using:
a reference occasion uncertainty value associated with the reference PRS occasion, and
an uncertainty value of the plurality of uncertainty values.

43. The apparatus of claim 42, further comprising:
means for transmitting the time difference uncertainty value to the mobile network.

44. The apparatus of claim 42, further comprising:
means for calculating a position uncertainty of the apparatus using the time difference uncertainty value.
